(19) United States
(12) Patent Application Publication
(10) Pub. No.: US 2012/0229567 A1
(43) Pub. Date: Sep. 13, 2012

(54) Recording Apparatus

(75) Inventors: Atsuki Sawata, Funabashi-shi (JP); Seiji Kawabata, Matsumoto-shi (JP)

(73) Assignee: SEIKO EPSON CORPORATION, Tokyo (JP)

(21) Appl. No.: 13/416,428

(22) Filed: Mar. 9, 2012

(30) Foreign Application Priority Data
Mar. 10, 2011 (JP) 2011-052615

(51) Int. Cl. B41J 2/015

(52) U.S. Cl. 347/37

(57) ABSTRACT

A recording apparatus includes a carriage to which an ink jet head is equipped, a first guide unit and a second guide unit for guiding reciprocation of the carriage, a roller for transporting a recording medium to which a recording process is performed by the ink jet head, and a roller frame supporting the roller and partially configuring the first guide unit.

### CROSS-REFERENCE TO RELATED APPLICATION

The entire disclosure of Japanese Patent Application No. 2011-052615, filed Mar. 10, 2011 is expressly incorporated by reference herein.

### BACKGROUND

1. Technical Field

The present invention relates to a recording apparatus for guiding reciprocation of a carriage to which an ink jet head is equipped, at two vertical locations.

2. Related Art

In the related art, a recording apparatus including a main guide member (main guide rod) and an auxiliary guide member (front guide rod) for guiding reciprocation of a carriage to which an ink jet head is equipped, and a discharging mechanism (transporting roller, a transporting driven roller and a transporting belt) for discharging paper to which printing is performed by the ink jet head (see JP-A-2001-030562) is known.

The recording apparatus drives a transporting roller to transport (discharge) a paper by attaching the paper onto the transporting belt to which tension is applied.

A discharging mechanism of the above recording apparatus is supported by a separate frame from the auxiliary guide member due to the configuration thereof. Therefore, the frame supporting the auxiliary guide member and the discharging mechanism should have necessary rigidity (strength), respectively.

In particular, in consideration of the precision of printing by the ink jet head, the auxiliary guide member needs to have so sufficient strength that it does not bend accompanying the reciprocation of the carriage. For this reason, the auxiliary guide member is formed thick such that the auxiliary guide member ensures that it does not bend due to rigidity alone. In other cases, a plurality of reinforcing members should be provided in the reciprocating direction. In this case, a large installation space needs to be ensured in the recording apparatus.

### SUMMARY

An advantage of some aspects of the invention is to provide a recording apparatus which may have a small size while ensuring necessary strength with respect to a frame structure supporting a carriage and a roller.

According to an aspect of the invention, there is provided a recording apparatus, which includes a carriage to which an ink jet head is equipped; a first guide unit and a second guide unit for guiding reciprocation of the carriage; a roller for transporting a recording medium to which a recording process is performed by the ink jet head; and a roller frame for supporting the roller and partially configuring the first guide unit.

According to this configuration, the first guide unit may easily ensure the rigidity (strength) of the first guide unit due to being supported by the integrally formed roller frame. In addition, as it is possible to use a reinforcing portion such as a rib together, the first guide unit and the roller frame may be configured compactly, in comparison to a case where they are independently prepared. By doing so, the installation space of the first guide unit and the roller frame in the recording apparatus may be reduced. Therefore, as it is possible to configure the first guide unit with no warping, the ink jet head and the recording medium may be maintained in parallel to each other (the degree of parallelization is maintained), and meanwhile the installation space may be restricted by reducing the size of the recording apparatus.

In this case, one of the first guide unit and the second guide unit is preferably installed further upstream in a transport direction of the recording medium than the ink jet head in a transporting path along which the recording medium is transported, and the other is preferably installed further downstream in the transport direction of the recording medium than the ink jet head.

According to this configuration, due to providing a first guide and a second guide either side of the ink jet head in the transport direction of the recording medium at the transporting path of the recording medium, the carriage may be reciprocated while the distance between the carriage and the recording medium are accurately stabilized.

In this case, the carriage is preferably supported in a slanted posture by the main guide member and the auxiliary guide member.

According to this configuration, the size of the recording apparatus may be further reduced while ensuring suitable reciprocation of the carriage.

In this case, the roller frame may have a bent shape, and the first guide unit is preferably formed at the end of one-side of the roller frame.

In addition, in this case, the first guide unit is preferably formed at an end portion of the plate-shaped member which is bent into a “V” shape profile.

In addition, in this case, the first guide unit is preferably formed at an end portion of the plate-shaped member which is bent into a “U” shape profile.

In addition, in this case, the first guide unit is preferably formed at an end portion of the plate-shaped member which is bent into a crank shape profile.

According to this configuration, the carriage is supported by engagement from one side with respect to the first guide unit. For example, the carriage may pinch the first guide unit or be supported at the inner side of the “V” or “U” shape. By doing so, the carriage may be maintained to have an upright posture by the main guide member and the second guide unit.

In this case, an earth piece for earthing the first guide unit and the roller frame may be further provided, so that the earth piece is preferably integrally made of a metallic plate together with the first guide unit and the roller frame.

According to this configuration, the first guide unit, the roller frame and the earth piece are integrally made of a metallic plate, and the earth piece is grounded. By doing so, by using the roller frame, it is possible to shield noise such as electromagnetic waves generated from an electronic substrate or the like.

### BRIEF DESCRIPTION OF THE DRAWINGS

The invention will be described with reference to the accompanying drawings, wherein like numbers reference like elements.

FIG. 1 is a perspective view showing an appearance of a recording apparatus.

FIG. 2 is a side cross-sectional view showing the recording apparatus where paper is separated from a feeding roller.

FIG. 3 is a side cross-sectional view showing the recording apparatus where paper compressively contacts a feeding roller.

FIG. 4 is a perspective view showing the recording apparatus from which a case is detached.

FIG. 5 is a perspective view (in a front surface direction) of an apparatus frame according to the first embodiment.

FIG. 6 is a perspective view (in a rear surface direction) showing the apparatus frame according to the first embodiment.

FIG. 7 is a side cross-sectional view showing a printing unit according to the first embodiment.

FIG. 8 is a front cross-sectional view showing the printing unit according to the first embodiment.

FIG. 9 is a side cross-sectional view showing a printing unit according to a second embodiment.

FIG. 10A is a side cross-sectional view showing a discharging frame, an auxiliary slide unit and a guide mechanism according to a third embodiment, and FIG. 10B is a side cross-sectional view showing a modified example thereof.

### DESCRIPTION OF EXEMPLARY EMBODIMENTS

Hereinafter, a recording apparatus according to an embodiment of the invention will be described with reference to the accompanying drawings. The recording apparatus performs a desired recording process while transporting paper (recording medium) retained in an upright posture and retains (stocks) the ejected and recorded paper in a standing state. In addition, as shown in each figure, the X-axis (left and right) direction, the Y-axis (front and rear) direction and the Z-axis (up and down) direction are defined in the following description.

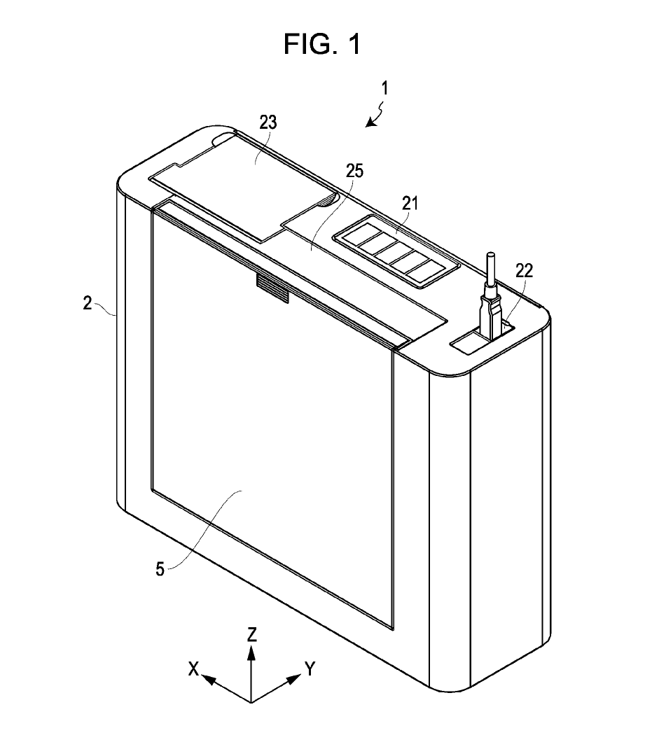

As shown in FIGS. 1 to 4, an appearance of a recording apparatus 1 is configured by means of a case 2 having a thin box-shaped structure where the dimension in the Z-axis direction is greater than the dimensions in the X-axis and Y-axis directions. In addition, the so-called longitudinal recording apparatus 1 is configured so that the installation area is reduced by decreasing the dimensions in the X-axis and Y-axis directions. In addition, the dimension in the X-axis direction restricts the dimension in the Y-axis direction so as to be determined by the maximum width of a paper P used, thereby promoting the control of the installation area.

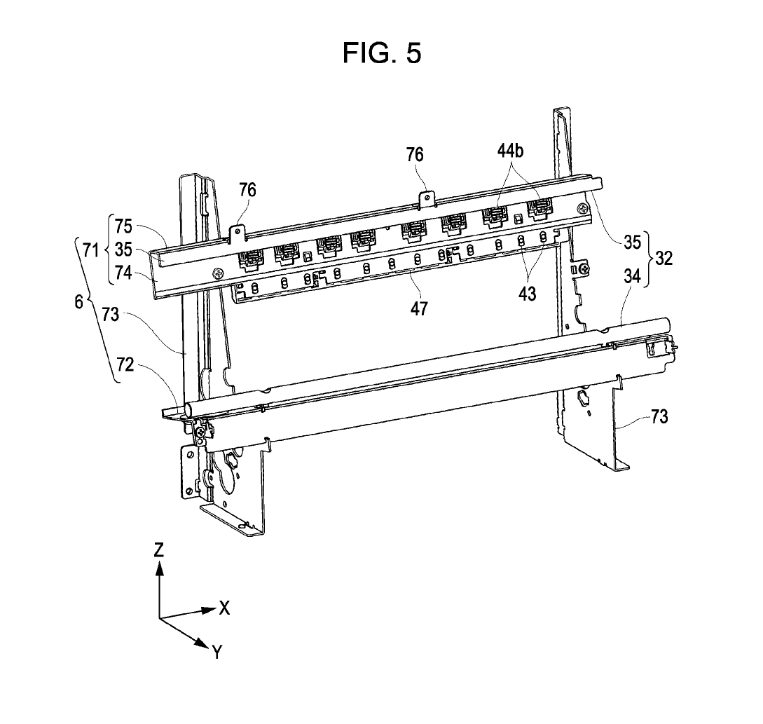

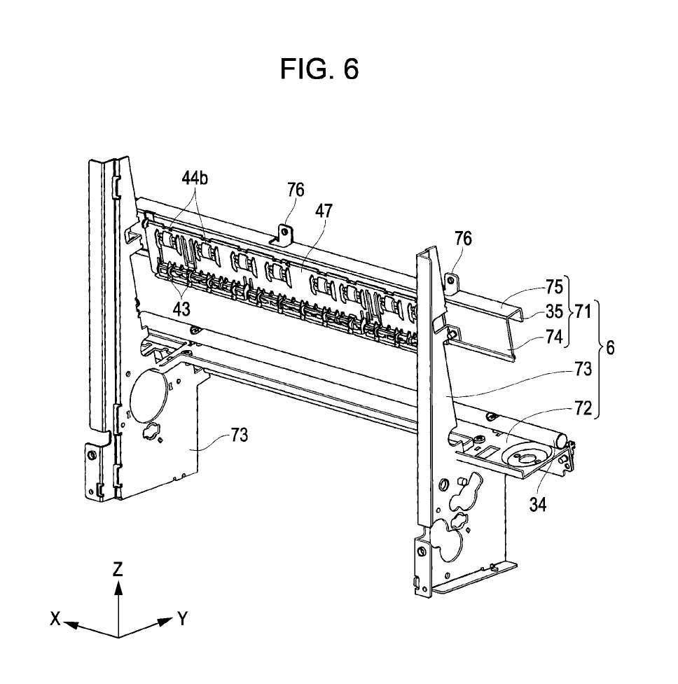

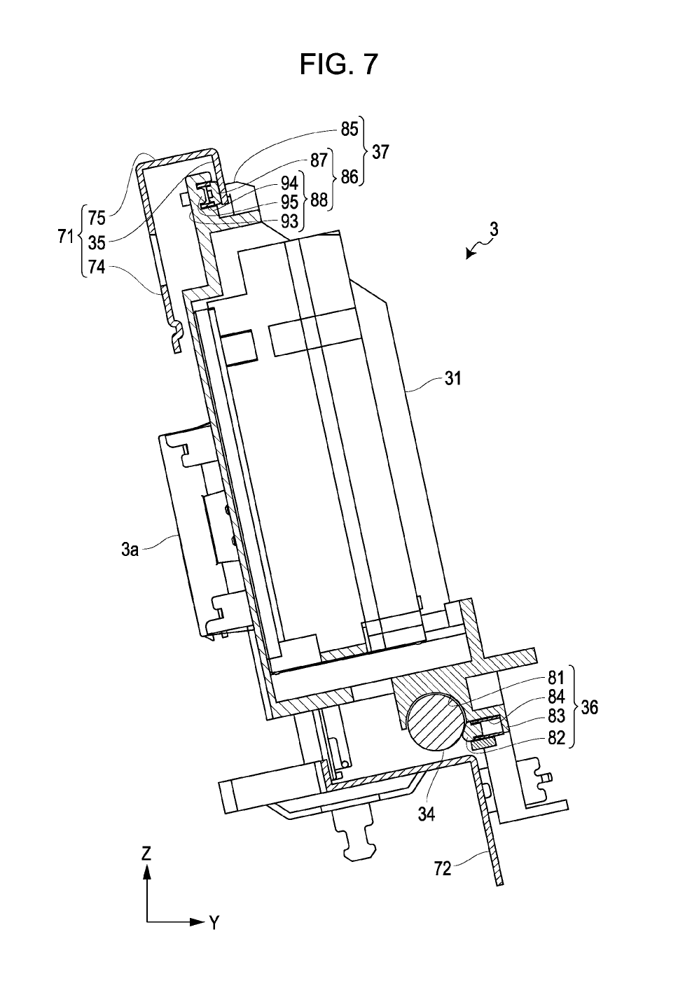

In addition, the recording apparatus 1 includes a printing unit 3 (see FIG. 7) for performing a printing process to the paper P approaching onto a transporting path by means of an ink jet method, a transporting unit 4 for sending each sheet of paper P along the transporting path, a recording medium cassette 5 receiving the paper P in an upright posture and detachably mounted to the case 2, an apparatus frame 6 (see FIGS. 5 and 6) supporting the transporting unit 4, the printing unit 3 or the like, and a control device (not shown) for generally controlling the entire apparatus.

On the surface of the case 2, a manipulation panel 21 having manipulation buttons or the like arranged thereon, a cable terminal 22 connecting to a cable for the connection to a PC or the like, and a cartridge cover 23 for opening or closing a cartridge mounting unit (not shown) to which a plurality of ink cartridges (not shown) is detachably mounted are installed. In addition, on the surface of the case 2, a paper discharge hole cover 25 for opening or closing a paper discharge hole 24 which discharges a recorded paper P (recording medium) is installed. Moreover, the paper discharge hole cover 25 is opened or closed by a user, even when recording is performed in a closed state, it may be automatically opened by means of an opening/closing mechanism (not shown).

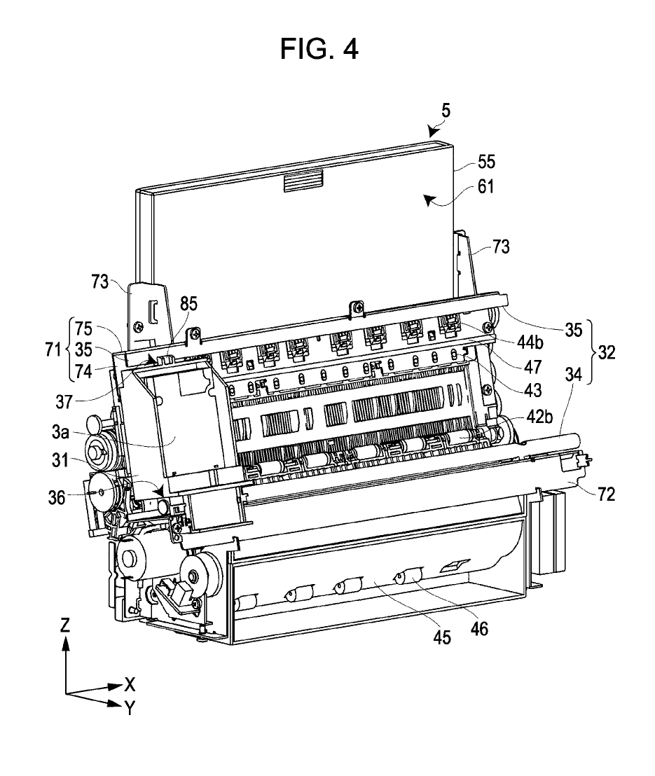

The printing unit 3 includes a carriage 31 installed at a downstream side of a pair of transporting rollers 42, described later, and having an ink jet head 3a loaded thereon, a guide mechanism 32 (see FIG. 4) for guiding reciprocation of the carriage 31 at two locations, a moving mechanism (not shown) for reciprocating the carriage 31, and a guide member 33 installed at a location opposite to the ink jet head 3a.

The guide mechanism 32 is a second guide unit extending in the X-axis direction and includes a main guide member 34 and an auxiliary guide member 35 serving as a plate-shaped first guide unit installed separated in the Z-axis (upper and lower) direction with respect to the main guide member 34 and extending in the X-axis direction.

The carriage 31 includes a main slide unit 36 slidably supported by the main guide member 34 and an auxiliary slide unit 37 slidably supported by the auxiliary guide member 35 in a state of pinching the auxiliary guide member 35. Therefore, the carriage 31 is slidably supported in the X-axis direction (reciprocating direction) by one pair of the main guide member 34 and the auxiliary guide member 35 separated in the Z-axis direction.

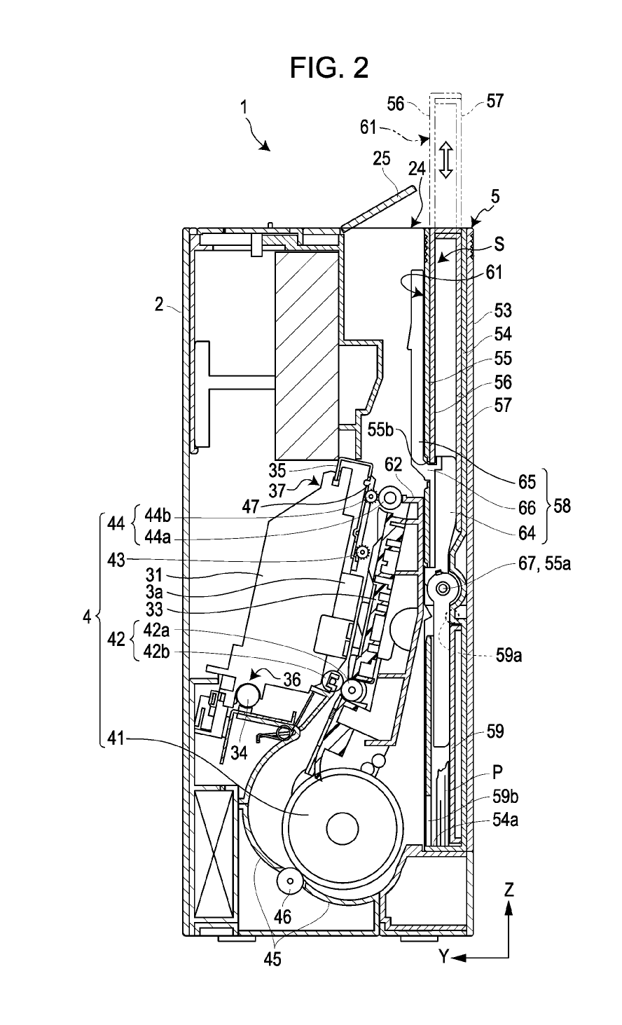

The carriage 31 is installed to be reciprocatable along the main guide member 34 extending in the X-axis direction by a moving mechanism (motor). In addition, as shown in FIG. 2, the carriage 31 generates a force to pivot on the main guide member 34 so as to be installed with a slanted posture (upright posture). Here, the auxiliary slide unit 37 installed at the upper side of the carriage 31 consistently maintains the posture of the carriage 31 by pinching the auxiliary guide member 35 extending in the X-axis direction. Moreover, the carriage 31 and the guide mechanism 32 will be described in detail later.

Though not shown in the figures, the moving mechanism is configured by fastening a belt engaged with the main slide unit 36 with respect to a driving pulley and a driven pulley installed at the main guide member 34 side. Though described in detail later, the main guide member 34 is installed at a lower side in the Z-axis direction further to the auxiliary guide member 35. In addition, since the moving mechanism is also installed near the main guide member 34 at a lower side, the center of the recording apparatus 1 may be lowered. By doing so, the stability may be improved when the recording apparatus 1 is installed.

The guide member 33 configures a part of the transporting path and defines a gap (work gap) between a recording surface of the paper P and the ink jet head 3a. In addition, at the guide member 33, a concave portion is formed receiving the ink discharged to regions deviated from the edge of the paper P when borderless printing is performed at a location opposite to the ink jet head 3a. In the concave portion, an ink absorbing material (not shown) absorbing ink is installed. In addition, furthermore, at the lower portion of the guide member 33, a waste liquid tank (not shown) is disposed for storing disposed ink.

In addition, even though this embodiment adopts a so-called off-carriage type where the ink cartridge is independently installed from the carriage 31, a so-called on-carriage type where the ink cartridge is loaded on the carriage 31 may also be used. In addition, even though this embodiment is applied to a so-called serial printer where the carriage 31 performs recording while moving in the X-axis direction, a fixed-type ink jet head 3a covering the width of the paper P may also be used. Further, the printer is not limited to the ink jet method but may use other recording methods.

The transporting unit 4 includes, from the upstream side, a feeding roller 41 installed at a location opposite to the front end of the mounted recording medium cassette 5 to send the paper P supplied from the recording medium cassette 5 to the downstream side, a pair of transporting rollers 42 for transporting the paper P to the printing unit 3, a guide roller 43 for preventing the uplift of the paper P from the guide member 33 of the printing unit 3, and a pair of paper ejection rollers 44 for discharging the recorded paper P from the printing unit 3.

The feeding roller 41, in a state where the front end of the paper P is contacted, sends the paper P downwards through rotation due to a motor (not shown). At a location opposite to the outer circumference of the feeding roller 41, installed is a guide member 45 forming an approximately U-shaped transporting path where the curvature of the paper P is inverted. In addition, the reference symbol 46 represents an auxiliary driven roller which aids sending of the paper P by the feeding roller 41. In other words, the feeding roller 41 and the auxiliary driven roller 46 have a nip roller shape.

One pair of transporting rollers 42 has a transportation driving roller 42a driven by a driving motor (not shown) to rotate, and a transporting driven roller 42b biased by a biasing means (not shown) toward the transportation driving roller 42a, thereby forming a nip roller shape. The transporting driven roller 42b is driven to rotate by pinching the paper P between the transportation driving roller 42a and the transporting driven roller 42b.

One pair of paper ejection rollers 44 has a paper ejection driving roller 44a driven by a driving motor (not shown) to rotate, and a paper ejection driven roller 44b biased by a biasing means (not shown) toward the paper ejection driving roller 44a, thereby forming a nip roller shape. The surface of the paper ejection driving roller 44a is made of rubber or the like. The paper ejection driven roller 44b is formed to have a spur shape (star wheel) and is driven to rotate by pinching the paper P between the paper ejection driving roller 44a and the paper ejection driven roller 44b. In addition, the paper ejection driven roller 44b and the guide roller 43 are rotatably retained to a roller holder 47.

In addition, though not shown in the figures, the feeding roller 41, the transportation driving roller 42a and the paper ejection driving roller 44a are respectively configured with a rotary shaft extending in the width direction of the paper P (X-axis direction) and a plurality of roller bodies axially located at the rotary shaft at an arbitrary interval. In addition, as shown in FIG. 4, in the auxiliary driven roller 46, the transporting driven roller 42b, the guide roller 43 and the paper ejection driven roller 44b, respectively, a plurality of roller bodies axially located at the rotary shaft are installed in the X-axis direction at an arbitrary interval.

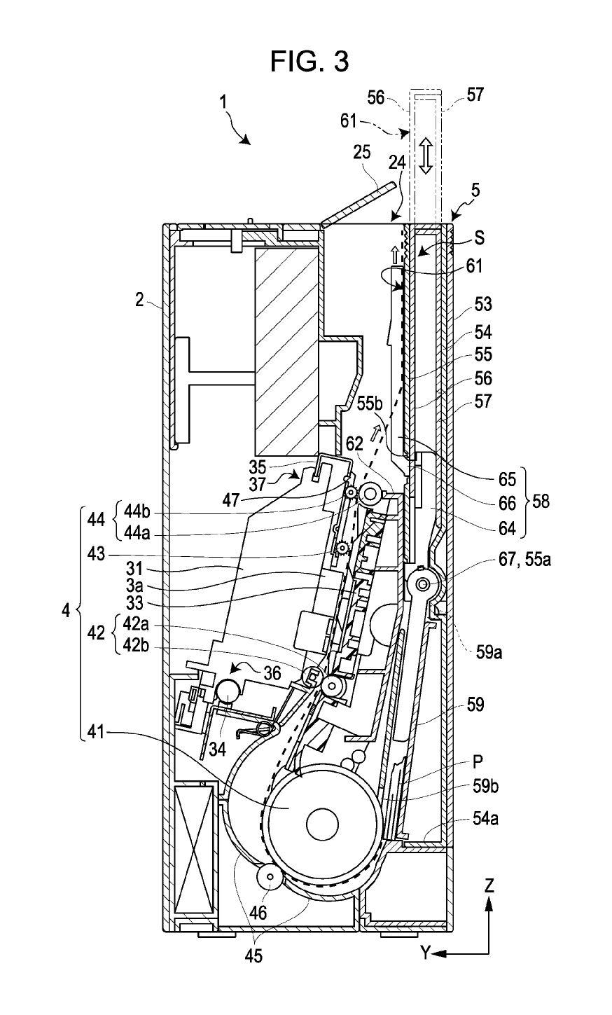

The paper P sent downwards is inverted upwards by the feeding roller 41 and the guide member 45 and is sent to the pair of transporting rollers 42. The paper P is interposed between the pair of transporting rollers 42 and is sent to the printing unit 3. The paper P recorded by the printing unit 3 moves upwards by means of the guide roller 43 and the pair of paper ejection rollers 44 while slidably contacting the retaining surface 61 (described later) of the recording medium cassette 5 (see the dash line in FIG. 3). The lower end of the ejected paper P is supported by a receiving unit 62 installed at the apparatus frame 6 near the paper ejection driving roller 44a with an upright posture. In addition, the guide roller 43 is configured with a spur shape roller (star wheel).

The front end portion of the receiving unit 62 at the paper ejection driving roller 44a side is bent upwards so that the lower end of the supported paper P does not drop out or contact the paper ejection driving roller 44a. In addition, a plurality of receiving units 62 are arranged in the X-axis direction at an arbitrary interval to enter among a plurality of paper ejection driving rollers 44a arranged at an arbitrary interval. In other words, the receiving units 62 have an approximately comb tooth shape as a whole.

Subsequently, the recording medium cassette 5 will be described with reference to FIGS. 2 and 3. The recording medium cassette 5 is detachably mounted to the case 2 by sliding in the Z-axis direction. In addition, since the inside of the recording apparatus 1 is exposed by detaching the recording medium cassette 5, inconveniences such as jamming of the paper P on the transporting path may be easily solved.

The recording medium cassette 5 includes a cassette case unit 53 which becomes one surface of the case 2 when being mounted and configures a framework of the recording apparatus 1, a body tray 54 formed with a tray shape, an upper outside cover 55 for opening or closing the paper receiving space S receiving the paper P, an upper inside cover 56 installed to slide with respect to the upper outside cover 55 so as to protrude from the upper end of the body tray 54, an upper slide tray 57 installed to be slidable with respect to the body tray 54 so as to protrude from the upper end of the body tray 54, an edge guide 58 installed to be slidable with respect to the upper outside cover 55 in the X-axis direction, and a movable tray 59 for oscillating the front end of the paper P received in the paper receiving space S.

At the lower end portion of the body tray 54, formed is a paper front end support wall 54a which supports the front end of the received paper P. The paper P received in a state where the recording medium cassette 5 is mounted is supported in a state where its front end contacts the paper front end support wall 54a.

The upper outside cover 55 pivots on a pair of right and left pivoting points 55a installed at the approximate center portion of the body tray 54 in the vertical direction. By opening the upper outside cover 55, the paper receiving space S appears, and the paper P may be received therein. In addition, the outer circumference of the upper outside cover 55 (the surface oriented to the inside of the apparatus when being mounted) serves as an advantageous retaining surface 61 which retains (stores) the recorded paper P.

The upper inside cover 56 slides with respect to the upper outside cover 55, and the upper slide tray 57 slides with respect to the body tray 54, respectively, so as to conform to the length of the paper P in the Z-axis direction and expand and contract the paper receiving space S. In addition, when the upper inside cover 56 is elongated, the outer surface of the upper inside cover 56 extends to stand in line from the outer surface of the upper outside cover 55, so that the retaining surface 61 extends in the Z-axis direction.

The edge guide 58 includes a supplying side guide 64 for guiding the paper P received in the paper receiving space S, a discharging side guide 65 for guiding the paper P retained to the retaining surface 61, and a guide connection unit 66 slidably supported by an elongated hole 55b formed to extend through the upper outside cover 55 in the X-axis direction to connect the discharging side guide 65 to the supplying side guide 64. For this reason, by displacing one of the supplying side guide 64 and the discharging side guide 65, the other of them may also be displaced simultaneously.

At the supplying side guide 64, a guide pivoting point 67 is installed at the same axis as the pair of right and left pivoting points 55a. Therefore, the supplying side guide 64, located higher than the guide pivoting point 67, pivots together with the upper outside cover 55. In addition, the pair of right and left oscillation points 59a is installed to be dislocated downwards and rearwards from the pivoting point 55a and the guide pivoting point 67 to a small extent. By doing so, the supplying side guide 64 located lower than the guide pivoting point 67 may pivot together with the movable tray 59.

The movable tray 59 is installed to a lower side of the body tray 54 and pivots on the pair of right and left oscillation points 59a, to oscillate between a state where the front end of the received paper P compressively contacts the feeding roller 41 (see FIG. 3) and a state where the front end of the received paper P is separated therefrom (see FIG. 2) (so-called hopper). In addition, at the movable tray 59, a plurality of contact openings 59b are formed at an arbitrary interval along the X-axis direction so as to compressively contact the feeding roller 41 at a location corresponding to the front end of the paper P.

Next, as shown in FIGS. 5 and 6, the apparatus frame 6 supports the roller holder 47, and includes a discharging frame 71 integrally formed with the auxiliary guide member 35, a guide frame 72 for supporting the main guide member 34, and a pair of standing frames 73 for supporting both end portions of the discharging frame 71 and the guide frame 72. In other words, the apparatus frame 6 has a rigid frame structure. In addition, the term “roller frame” used in the claims represents the discharging frame 71.

The discharging frame 71 includes a holder support unit 74 for supporting the auxiliary guide member 35 of the guide mechanism 32 and the roller holder 47, and a connection unit 75 for connecting the auxiliary guide member 35 and the holder support unit 74, which are integrally formed. The discharging frame 71 is screwed to the pair of standing frames 73 at both right and left end portions of the holder support unit 74. The discharging frame 71 is formed by bending one metallic plate into an inversed U shape at a side view. In other words, the connection unit 75 serves as a rib (reinforcing unit) of the auxiliary guide member 35 and the holder support unit 74. For this reason, the rigidity (strength) required for the auxiliary guide member 35 and the holder support unit 74 may be easily ensured. In addition, the auxiliary guide member 35 and the holder support unit 74 may be configured in a compact design, compared with the case where they are prepared independently. By doing so, the discharge space of the discharging frame 71 (the auxiliary guide member 35) in the recording apparatus 1 may be reduced.

The roller holder 47 retaining the paper ejection driven roller 44b and the guide roller 43 is fit and fixed to the holder support unit 74 from the transporting path side (the guide member 33 side) of the paper P. Meanwhile, the carriage 31 is engaged from the surface of the holder support unit 74 at an opposite side to the roller holder 47. By doing so, the carriage 31 does not interfere in the paper ejection driven roller 44b and the guide roller 43. In addition, the carriage 31 and the roller holder 47 may be supported to the discharging frame 71 with good balance. By doing so, the carriage 31 may be reciprocated with good precision.

In addition, the discharging frame 71 has a pair of earth pieces 76 for earthing the auxiliary guide member 35 and the discharging frame 71. Each earth piece 76 is formed by notching a part of the connection unit 75 and extending the bent portion, and extends upwards from the auxiliary guide member 35. At each earth piece 76, an electronic substrate (not shown) is fixed by screws. By doing so, by using the discharging frame 71, noise such as electromagnetic waves generated by the electronic substrate may be shielded.

The guide frame 72 is a member having an angled (L) shape formed by bending a metallic plate. The guide frame 72 is located at the lower portion of the discharging frame 71 and fixed to the pair of standing frames 73 by engagement.

The pair of standing frames 73 is installed to be separated at right and left locations (in the X-axis direction) and has an approximate trapezoidal shape having a thin upper end at a side view. The pair of standing frames 73 supports both end portions of the printing unit 3, the feeding roller 41, the transportation driving roller 42a or the like in addition to the guide frame 72 and the discharging frame 71. In addition, the pair of standing frames 73 is fixed to the inner side of the case 2.

Next, the main guide member 34 and the auxiliary guide member 35 of the guide mechanism 32 will be described with reference to FIGS. 4 to 6. The main guide member 34 is a rod-shaped member (round bar) with a circular cross-section, is located at a lower side in the Z-axis direction, and is screwed to the guide frame 72.

Meanwhile, as described above, the auxiliary guide member 35 is integrally formed with the discharging frame 71. The auxiliary guide member 35 is located higher than the main guide member 34 in the Z-axis direction, and is supported by the pair of standing frames 73 via the discharging frame 71. The carriage 31 is maintained with a slanted posture (upright posture) by means of the main guide member 34 and the auxiliary guide member 35. Since the auxiliary guide member 35 is integrally formed with the discharging frame 71, the rigidity (strength) of the auxiliary guide member 35 may be easily ensured. Therefore, in order to configure the auxiliary guide member 35 with no warping, the ink jet head 3a and the paper P may be maintained in parallel to each other (the degree of parallelization is maintained), and meanwhile the installation space may be restricted by reducing the size of the recording apparatus 1.

Next, the main slide unit 36 and the auxiliary slide unit 37 of the carriage 31 will be described in detail with reference to FIGS. 4, 7 and 8. As shown in FIGS. 4 and 7, the main slide unit 36 is installed at the lower end portion of the carriage 31 in the Z-axis direction. The main slide unit 36 includes an engagement portion 81 engaged with the main guide member 34 from an upper side, a contact portion 82 contacting the main guide member 34 engaged with the engagement portion 81, and a main support portion 83 having a main coil spring 84 for biasing the contact portion 82 toward the main guide member 34.

The engagement portion 81 is formed to have a semi-circular recess at a side view along the circumferential surface of the main guide member 34. By doing so, the carriage 31 is guided by the main guide member 34 slidably engaged with the engagement portion 81 to reciprocate.

The contact surface of the contact portion 82 contacting the surrounding surface of the main guide member 34 is formed with a slant, the contact portion 82 is biased by the main coil spring 84 from the right lower portion with a slant in the Z-axis direction in FIG. 7 so as to tightly press the main guide member 34. For this reason, the biasing force of the main coil spring 84 is oriented toward the axial core of the main guide member 34 via the contact portion 82.

As shown in FIGS. 4, 7 and 8, the auxiliary slide unit 37 includes a slide support portion 85 slidably contacting one surface of the auxiliary guide member 35, and a pair of slide pressing portions 86 slidably contacting the other surface of the auxiliary guide member 35.

The slide support portion 85 is located at the upper end surface of the carriage 31 and is installed to protrude from an approximate center in the X-axis direction. The slide support portion 85 slidably contacts the auxiliary guide member 35 from an opposite side to the holder support unit 74.

The slide pressing portions 86 are respectively located at the upper end surface of the cartridge 31 and are installed to protrude at deviated locations to both outer sides in the X-axis direction from the slide support portion 85. In detail, at an approximate center of the pair of slide pressing portions 86 in the X-axis direction, the slide support portion 85 is installed. As described above, since the pair of slide pressing portions 86 is separated from each other, it is possible to compress tilting (pivoting) of the carriage 31 due to inertia during initial moving. Therefore, the vibration at the movement of the carriage 31 may be reduced so that the ink jet head 3a and the paper P (the guide member 33) may be maintained in parallel to each other (the degree of parallelization is maintained). By doing so, the precision of recording (printing) by the ink jet head 3a may be improved. In addition, the pair of installed slide pressing portions 86 is separated in the reciprocating direction as greatly as possible so as to improve the stability when the carriage 31 is reciprocating.

Each slide pressing portion 86 includes a pressing portion body 87 slidably contacting the auxiliary guide member 35 from the holder support unit 74 side, and a biasing portion 88 having an auxiliary coil spring 94 for biasing the pressing portion body 87 toward the auxiliary guide member 35.

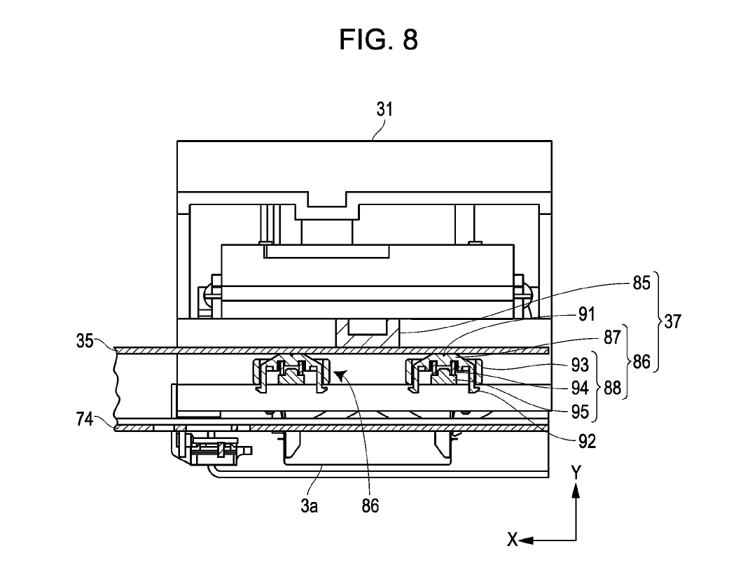

Each pressing portion body 87 is a cap-shaped member having a rectangular shape, seen in the Y-axis direction. At each pressing portion body 87, a grease groove 91 collecting grease (lubricant) is formed concave to elongate in the Z-axis direction, at the surface slidably contacting the auxiliary guide member 35 (see FIG. 8). Each pressing portion body 87 may reduce the resistance when the auxiliary guide member 35 is sliding. In addition, at each pressing portion body 87, installed is a regulating protrusion 92 contacting a body holder 93, described later, to regulate movement to the auxiliary guide member 35 (see FIG. 8). In addition, the grease groove 91 may also be further formed at the slide support portion 85.

Each biasing portion 88 includes a body holder 93 for slidably retaining the pressing portion body 87, an auxiliary coil spring 94 for biasing the pressing portion body 87 toward the auxiliary guide member 35, and an auxiliary support portion 95 which becomes a support of the auxiliary coil spring 94.

Each body holder 93 is a frame-shaped member formed to pass in the Y-axis direction so that the pressing portion body 87 is slidably retained, and protrudes from the upper end surface of the carriage 31. Each auxiliary support portion 95 protrudes from the upper end surface of the carriage 31 and engages in the range of each body holder 93.

The base end portion of each auxiliary coil spring 94 contacts the auxiliary support portion 95, and the front end thereof contacts the pressing portion body 87. In other words, each auxiliary coil spring 94 is supported by the auxiliary support portion 95 to lift up the pressing portion body 87 so that the auxiliary guide member 35 is tightly pressed thereto. In addition, each auxiliary coil spring 94 has such a biasing force as not to disturb the reciprocation of the carriage 31.

According to this configuration, the auxiliary guide member 35 may easily ensure its rigidity (strength) so as to be supported by the integrally formed discharging frame 71. In addition, the discharging frame 71 (the auxiliary guide member 35) may be configured compactly. By doing so, the size of the recording apparatus 1 may be reduced while ensuring suitable reciprocation of the carriage 31.

In addition, even though the auxiliary slide unit 37 according to this embodiment includes one slide support portion 85 and two slide pressing portions 86, the numbers of installed slide support portions 85 and installed slide pressing portions 86 are arbitrary. In addition, the installation locations of the slide support portion 85 and the slide pressing portion 86 may be exchanged.

### Second Embodiment

Subsequently, the discharging frame 71, the auxiliary slide unit 37 and the guide mechanism 32 according to a second embodiment will be described. In addition, the same feature as in the first embodiment will not be described.

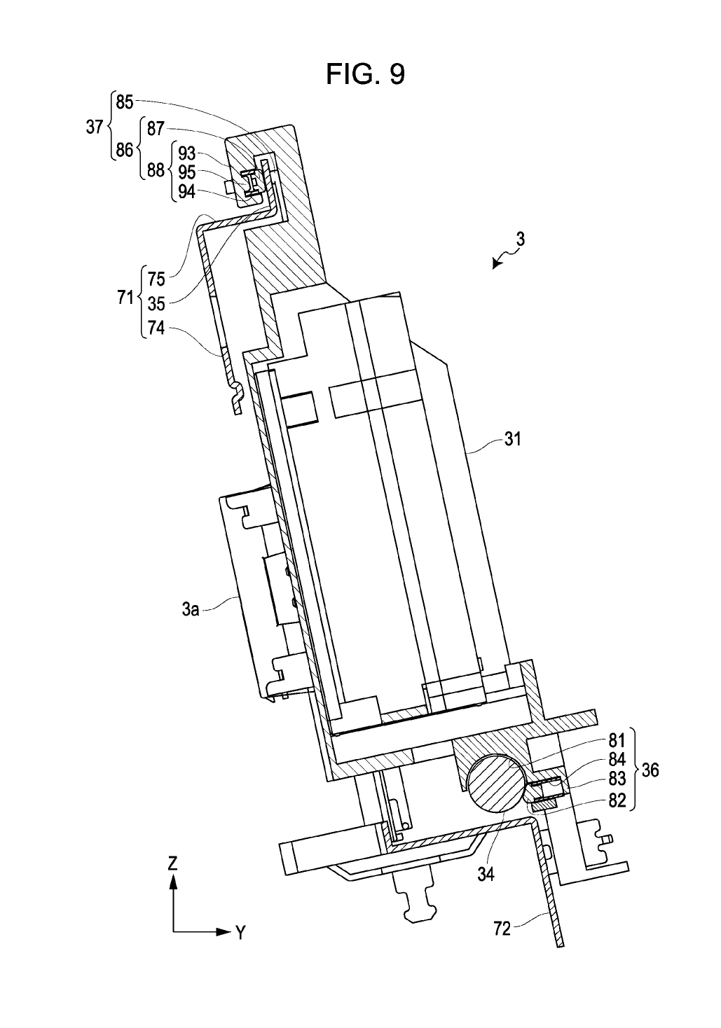

Even though the discharging frame 71 according to the first embodiment is formed to be bent in an inversed U shape in a side view, the discharging frame 71 may also be bent in a crank shape at a side view, as shown in FIG. 9. In this case, the auxiliary slide unit 37 of the carriage 31 is formed to run around the auxiliary guide member 35 upwards in the Z-axis direction. In detail, the body holder 93 of the biasing portion 88 is formed in an inversed U shape to run around the auxiliary guide member 35 upwards in the Z-axis direction.

According to this configuration, the rigidity (strength) of the auxiliary guide member 35 may be easily ensured with a compact configuration. By doing so, the size of the recording apparatus 1 may be reduced while ensuring suitable reciprocation of the carriage 31.

### Third Embodiment

Subsequently, the discharging frame 71, the auxiliary slide unit 37 and the guide mechanism 32 according to a third embodiment will be described. In addition, the same feature as in the first and second embodiments will not be described.

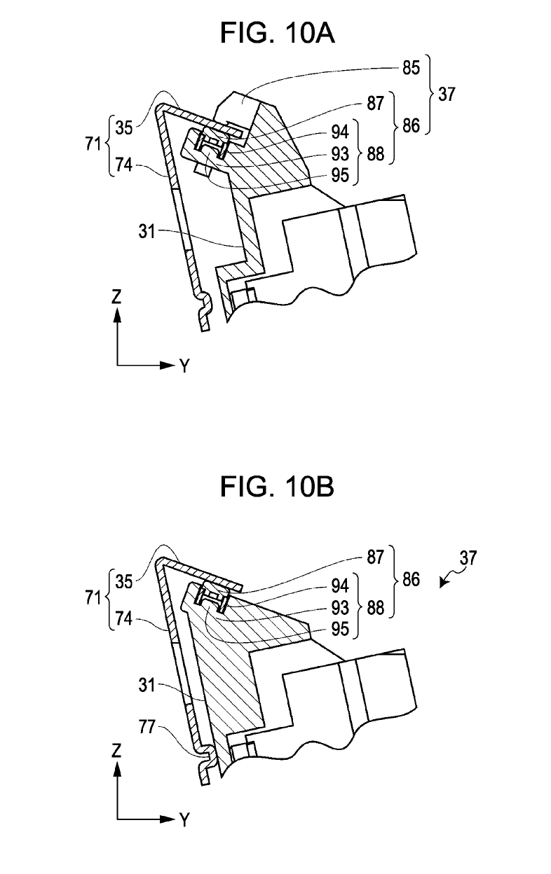

As shown in FIG. 10A, the discharging frame 71 according to the third embodiment is bent in a “V” shape at a side view. In other words, the discharging frame 71 connects to the holder support unit 74 so that the auxiliary guide member 35 has an acute angle since the connection unit 75 is excluded. In this case, the auxiliary slide unit 37 of the carriage 31 is configured to pinch the auxiliary guide member 35 by using the slide support portion 85 and the slide pressing portion 86, as in the first and second embodiments.

In addition, as shown in FIG. 10B, as a modified example of the auxiliary slide unit 37 according to the third embodiment, the auxiliary slide unit 37 may be engaged at an inner side of the “V” shape to slidably contact the lower surface of the auxiliary guide member 35. In this case, since the slide support portion 85 is excluded from the auxiliary slide unit 37, the pressing portion body 87 is biased by the auxiliary coil spring 94 and slidably contacts the lower surface of the auxiliary guide member 35.

In addition, a convex portion 77 extending in the X-axis direction may be formed at the surface of the holder support unit 74 at the surface of the carriage 31 side. The convex portion 77 slidably contacts the carriage 31 and supports the reciprocation of the carriage 31. In other words, the carriage 31 slidably contacts the auxiliary guide member 35 and the convex portion 77 to guide the reciprocation. By doing so, the work gap between the paper P and the ink jet head 3a is maintained consistently so as to implement good printing (recording). In addition, the convex portion 77 may be formed as a plurality of dot shapes.

What is claimed is:

1. A recording apparatus, comprising:
a carriage to which an ink jet head is equipped;
a first guide unit and a second guide unit for guiding reciprocation of the carriage;
a roller for transporting a recording medium to which a recording process is performed by the ink jet head; and
a roller frame for supporting the roller and partially configuring the first guide unit.

2. The recording apparatus according to claim 1, wherein one of the first guide unit and the second guide unit is installed further upstream in a transport direction of the recording medium than the ink jet head in a transporting path along which the recording medium is transported, and the other is installed further downstream in the transport direction of the recording medium than the ink jet head.

3. The recording apparatus according to claim 1,
wherein the roller frame has a bent shape,
wherein the first guide unit is formed at an end of one side of the roller frame.

4. The recording apparatus according to claim 1, wherein the carriage is supported in a slanted posture by the first guide unit and the second guide unit.

5. The recording apparatus according to claim 4,
wherein the first guide unit is installed at an upper side in the height direction of the slanted posture, and
wherein the second guide unit is installed at a lower side in the height direction of the slanted posture.

6. The recording apparatus according to claim 1,
wherein the roller frame is a plate-shaped member, and
wherein the first guide unit is formed by bending an end at one side of the plate-shaped member into a “V” shaped cross-section.

7. The recording apparatus according to claim 1,
wherein the roller frame is a plate-shaped member, and
wherein the first guide unit is formed by bending an end at one side of the plate-shaped member into a “U” shape cross-section.

8. The recording apparatus according to claim 1,
wherein the roller frame is a plate-shaped member, and
wherein the first guide unit is formed by bending an end at one side of the plate-shaped member into a crank shaped cross-section.

9. The recording apparatus according to claim 1, further comprising an earth piece for earthing the first guide unit and the roller frame,
wherein the earth piece is integrally made of a metallic plate together with the first guide unit and the roller frame.
